(19) United States
(12) Patent Application Publication
(10) Pub. No.: US 2026/0254546 A1
(43) Pub. Date: Aug. 27, 2026

(54) FREQUENCY INTERFERENCE DETECTION IN CELLULAR NETWORKS

(71) Applicant: NAGHSHE AVAL KEYFIAT COPORATION, Tehran (IR)

(72) Inventor: Abbas Azari, Tehran (IR)

(73) Assignee: Naghshe Aval Keyfiat Corporation, Tehran, OT (IR)

(21) Appl. No.: 18/695,098

(22) PCT Filed: Nov. 18, 2023
(86) PCT No.: PCT/IB2023/061661

§ 371 Date: Mar. 25, 2024

(51) Int. Cl. H04B 17/391; H04B 17/318; H04B 17/345

(52) U.S. Cl. CPC H04B 17/3912; H04B 17/318; H04B 17/345

(57) ABSTRACT

A method for frequency interference detection in a geographical region. The method includes dividing the geographical region into a plurality of areas, extracting a first plurality of key performance indicators (KPIs) from a database, assigning each respective KPI of the first plurality of KPIs to a respective point in a first points subset of a plurality of points, estimating a second plurality of KPIs based on the first plurality of KPIs for a second points subset of the plurality of points, estimating a respective level of frequency interference at each respective point of the plurality of points based on the first plurality of KPIs and the second plurality of KPIs, and displaying a distribution map of frequency interference in the geographical region by representing the respective level of frequency interference at each respective point of the plurality of points on the distribution map.

### TECHNICAL FIELD

The present disclosure generally relates to cellular networks, and particularly, to frequency interference in cellular networks.

### BACKGROUND ART

Mobile communication networks have been rapidly growing in terms of size and technology since their introduction. However, frequency interference may have been a major cause of degradation in cellular networks since they have been emerged. Current methods for removing sources of frequency interference in cellular networks may require continuous monitoring of every cell in a cellular network to detect performance degradation in a cell due to frequency interference [U.S. Pat. No. 9,288,022 B2], so that external sources of frequency interference may be removed in time. However, this approach may require a high computational cost in terms of time and resources due to a large number of cells in current cellular networks. There is, therefore, a need for a cost-efficient method for detecting sources of frequency interference in cellular networks.

### SUMMARY OF THE DISCLOSURE

This summary is intended to provide an overview of the subject matter of this patent, and is not intended to identify essential elements or key elements of the subject matter, nor is it intended to be used to determine the scope of the claimed implementations. The proper scope of this patent may be ascertained from the claims set forth below in view of the detailed description below and the drawings.

In one general aspect, the present disclosure describes an exemplary method for frequency interference detection in a geographical region at a given time. An exemplary method may include dividing the geographical region into a plurality of areas, extracting a first plurality of key performance indicators (KPIs) from a database, assigning each respective KPI of the first plurality of KPIs to a respective point in a first points subset of a plurality of points, estimating a second plurality of KPIs based on the first plurality of KPIs for a second points subset of the plurality of points, estimating a respective level of frequency interference at each respective point of the plurality of points based on the first plurality of KPIs and the second plurality of KPIs, and displaying a distribution map of frequency interference in the geographical region by representing the respective level of frequency interference at each respective point of the plurality of points on the distribution map. In an exemplary embodiment, each of the plurality of areas may be represented by a respective point of the plurality of points. An exemplary database may be stored in an operations support system (OSS) of a cellular network. An exemplary cellular network may include a plurality of cells, each of the plurality of cells may include three sectors of a plurality of sectors. In an exemplary embodiment, each respective KPI of the first plurality of KPIs may be associated with a respective sector of the plurality of sectors. An exemplary second points subset may include every point of the plurality of points outside the first points subset.

In an exemplary embodiment, dividing the geographical region into the plurality of areas may include dividing the geographical region into a plurality of equal square-shaped zones. Each exemplary respective zone of equal square-shaped zones may be represented by a respective point of the plurality of points. An exemplary respective point may be located at a center of the respective zone.

In an exemplary embodiment, assigning each respective KPI to the respective point in the first points subset may include assigning each respective KPI to a point of the plurality of points that may represent an area of the plurality of areas that may contain the respective point. In an exemplary embodiment, extracting each KPI for the respective location may include extracting one of a received signal strength indicator (RSSI) or an interference ratio of the respective sector at the respective location.

In an exemplary embodiment, estimating the second plurality of KPIs for the second points subset may include extracting a plurality of neighboring points of a respective point in the second points subset from the first points subset and estimating a respective KPI of the second plurality of KPIs for the respective point based on KPIs of the first plurality of KPIs that may be assigned to the plurality of neighboring points. Exemplary plurality of neighboring points may include points in the first points subset that have smaller distances than other points in the first points subset to the respective point in the second points subset.

In an exemplary embodiment, extracting the plurality of neighboring points from the first points subset may include selecting 6 to 8 points of the first points subset. In an exemplary embodiment, each of the 6 to 8 points may have smaller distances than other points in the first points subset to the respective point.

In an exemplary embodiment, estimating the respective KPI for the respective point may include interpolating values of the KPIs that are assigned to the plurality of neighboring points. In an exemplary embodiment, interpolating the values of the KPIs may include applying an inverse distance weighting interpolation method to the values of the KPIs.

In an exemplary embodiment, estimating the respective level of frequency interference at each respective point may include calculating a difference between a value of a respective KPI of one of the first plurality of KPIs or the second plurality of KPIs and a KPI threshold.

An exemplary respective KPI may be associated with each respective point. In an exemplary embodiment, displaying the distribution map may include assigning a color level to each respective point in the distribution map. An exemplary color level may be proportional to the difference between the value of the respective KPI and the respective threshold.

An exemplary method may further include detecting external sources of frequency interference by selecting one or more sectors from the plurality of sectors for anomaly detection according to the distribution map, detecting one or more abnormal sectors among the one or more sectors by applying an anomaly detection method to the one or more sectors, and estimating a number of the external sources of frequency interference by determining a number of different anomalies within the one or more abnormal sectors.

In an exemplary embodiment, determining the number of different anomalies may include extracting a plurality of variation patterns for respective KPIs of the first plurality of KPIs that may be associated with the one or more abnormal sectors over 20 days prior to the given time and determining the number of different anomalies as a number of different variation patterns among the plurality of variation patterns.

An exemplary method may further include removing the external sources of frequency interference and evaluating performance of the one or more abnormal sectors by applying a change point detection method to the one or more abnormal sectors over a time range. An exemplary time range may include about 20 days before removing the external sources and about 10 days after removing the external sources. An exemplary method may further include determining removal of frequency interference responsive to the performance being improved after removing the external sources, and determining existence of frequency interference responsive to the performance being degraded after removing the external sources.

Other exemplary systems, methods, features and advantages of the implementations will be, or will become, apparent to one of ordinary skill in the art upon examination of the following figures and detailed description. It is intended that all such additional systems, methods, features and advantages be included within this description and this summary, be within the scope of the implementations, and be protected by the claims herein.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A shows a flowchart of a method for frequency interference detection in a geographical region at a given time, consistent with one or more exemplary embodiments of the present disclosure.

FIG. 1B shows a flowchart for estimating a second plurality of KPIs for a second points subset, consistent with one or more exemplary embodiments of the present disclosure.

FIG. 1C shows a flowchart for detecting external sources of frequency interference, consistent with one or more exemplary embodiments of the present disclosure.

FIG. 2 shows a schematic of a geographical region, consistent with one or more exemplary embodiments of the present disclosure.

FIG. 3 shows a schematic of a cellular network in a geographical region, consistent with one or more exemplary embodiments of the present disclosure.

FIG. 4 shows a schematic of a cellular network in a geographical region divided into a plurality of areas, consistent with one or more exemplary embodiments of the present disclosure.

FIG. 5 shows a schematic of a plurality of neighboring points of a respective point, consistent with one or more exemplary embodiments of the present disclosure.

FIG. 6 shows a schematic of a distribution map, consistent with one or more exemplary embodiments of the present disclosure.

FIG. 7 shows a high-level functional block diagram of a computer system, consistent with one or more exemplary embodiments of the present disclosure.

### DESCRIPTION OF EMBODIMENTS

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

Herein is disclosed an exemplary detecting sources of frequency interference in a cellular network. An exemplary method may divide a geographical region that is covered by the cellular network into a number of areas and may extract key performance indicators (KPIs) for areas in which respective sectors of each cell are located from a database. An exemplary method may then estimate KPIs in the remaining areas of the geographical region based on the extracted KPIs. After obtaining all KPIs throughout the geographical region, an exemplary method may estimate a level of frequency interference at each area based on a KPI value at that area to generate a distribution map of frequency interference throughout the geographical region. Based on an exemplary distribution map, potential sectors that may contain anomalies may be selected for anomaly detection to detect abnormal sectors. Exemplary locations of abnormal sectors may be utilized to localize and remove external sources of frequency interference from the cellular network.

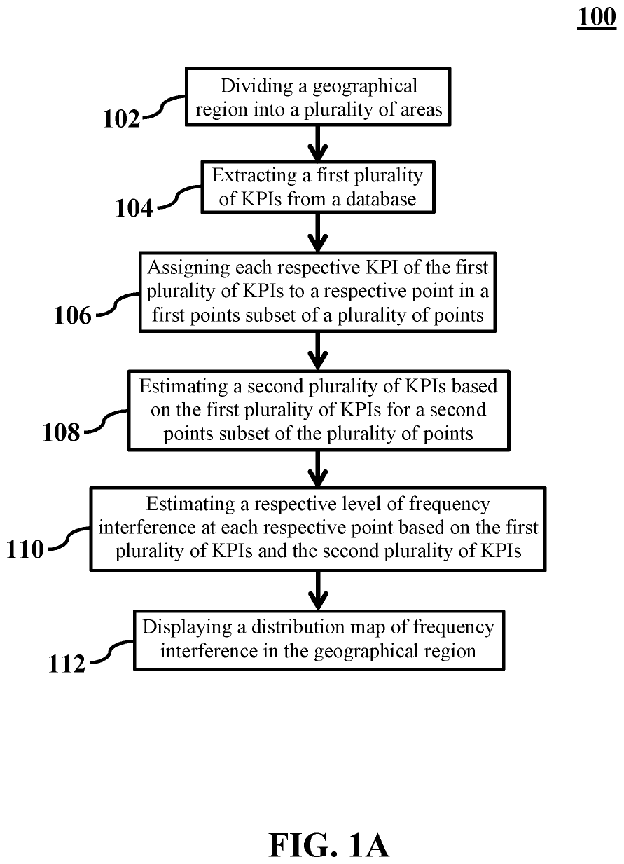

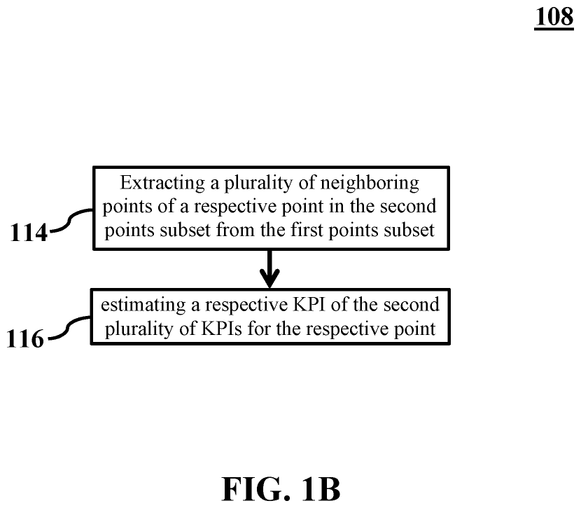

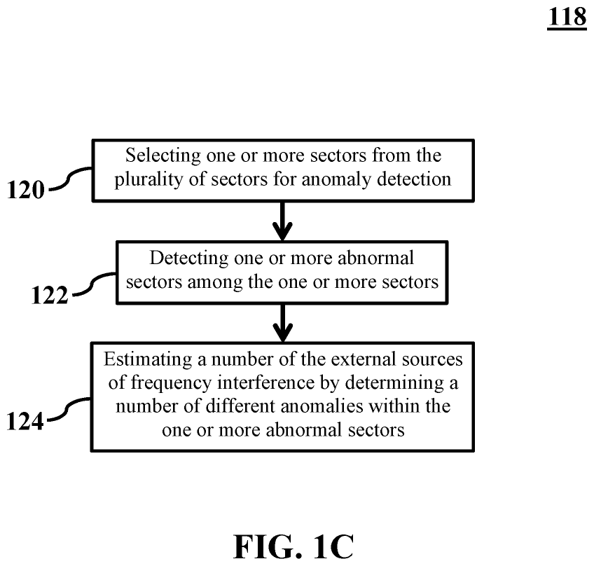

FIG. 1A shows a flowchart of a method for frequency interference detection in a geographical region at a given time, consistent with one or more exemplary embodiments of the present disclosure. An exemplary given time may include one or more specific time intervals during a day, a week, a month, etc., and may be determined based on different factors including occurrence rate and significance of frequency interference in an exemplary geographical region. An exemplary method 100 may include dividing the geographical region into a plurality of areas (step 102), extracting a first plurality of KPIs from a database (step 104), assigning each respective KPI of the first plurality of KPIs to a respective point in a first points subset of a plurality of points (step 106), estimating a second plurality of KPIs based on the first plurality of KPIs for a second points subset of the plurality of points (step 108), estimating a respective level of frequency interference at each respective point of the plurality of points based on the first plurality of KPIs and the second plurality of KPIs (step 110), and displaying a distribution map of frequency interference in the geographical region (step 112). In an exemplary embodiment, each of the plurality of areas may be represented by a respective point of the plurality of points. An exemplary database may be stored in an operations support system (OSS) of a cellular network.

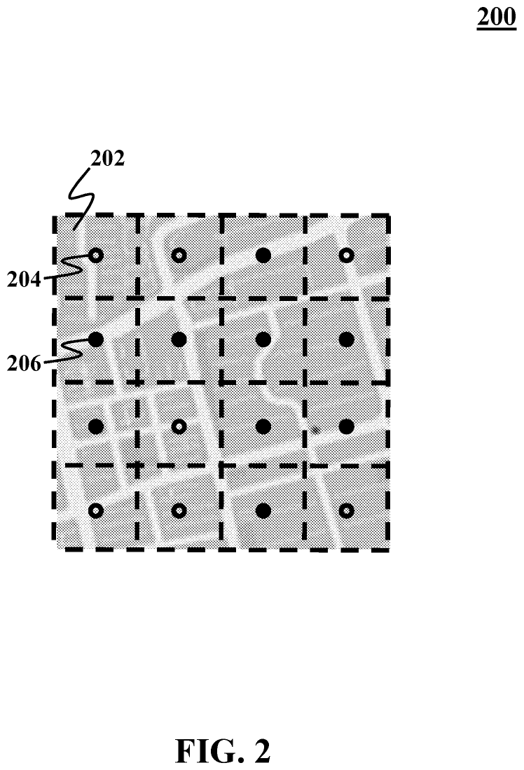

FIG. 2 shows a schematic of a geographical region, consistent with one or more exemplary embodiments of the present disclosure. In an exemplary embodiment, step 102 may include dividing a geographical region 200 into a plurality of areas. In an exemplary embodiment, dividing geographical region 200 into the plurality of areas may include dividing geographical region 200 into a plurality of equal square-shaped zones (for example, a zone 202). Each exemplary respective zone of equal square-shaped zones may be represented by a respective point of the plurality of points. For example, zone 202 may be represented by a point 204. An exemplary respective point may be located at a center of the respective zone. For example, point 204 may be located at a center of zone 202.

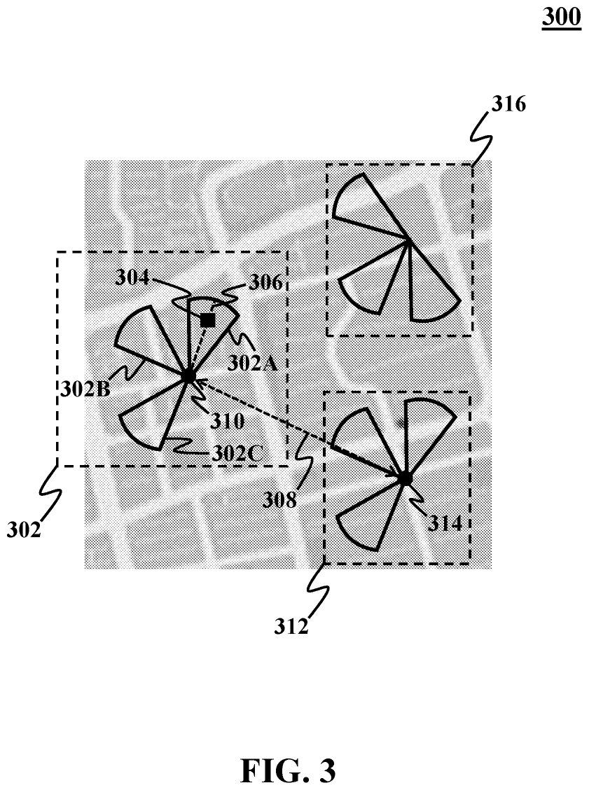

FIG. 3 shows a schematic of a cellular network in a geographical region, consistent with one or more exemplary embodiments of the present disclosure. An exemplary cellular network 300 may include a plurality of cells (for example, a cell 302). In an exemplary embodiment, each of the plurality of cells may include three sectors of a plurality of sectors. For example, cell 302 may include sectors 302A, 302B, and 302C of the plurality of sectors.

In further detail with respect to step 104, in an exemplary embodiment, each respective KPI of the first plurality of KPIs may be associated with a respective sector of the plurality of sectors. For example, for each of sectors 302A, 302B, and 302C a different KPI may be extracted from the database. In an exemplary embodiment, extracting the first plurality of KPIs may include extracting each respective KPI for a respective location at a respective distance from a respective sector of the plurality of sectors along an azimuth direction of the respective sector. For example, a KPI for sector 302A may be extracted at a location 304 along an azimuth direction 306 of sector 302A. In an exemplary embodiment, an “azimuth direction” may refer to a direction of signal propagation within a sector. For example, signals may propagate along azimuth direction 306 within sector 302A. In an exemplary embodiment, azimuth direction 306 may be determined by measuring an azimuth (i.e., an angle with respect to a north reference) of azimuth direction 306. An exemplary respective distance may be defined by the following:

0.15×dₘᵢₙ≤dₛ≤0.45×dₘᵢₙ Inequation (1)

where dₘᵢₙ is a minimum distance between an exemplary respective sector and a closest cell among the plurality of cells to a respective cell of the plurality of cells that may include the exemplary respective sector and dₛ is the exemplary respective distance. In an exemplary embodiment, for sector 302A, minimum distance dₘᵢₙ may be equal to a distance 308 between cell 302 that includes sector 302A and is located at a point 310 and a cell 312 that is located at a point 314 and is closer than other exemplary cells (for example, a cell 316) in cellular network 300 to cell 302. As a result, based on Inequation (1), respective distance dₛ for sector 302A may be equal to a distance between location 304 and point 310.

In an exemplary embodiment, extracting each KPI for location 304 may include extracting one of a received signal strength indicator (RSSI) or an interference ratio of sector 302A at location 304. In an exemplary embodiment, the RSSI of sector 302A may refer to a measurement of a power that is present in a received signal at location 304. In an exemplary embodiment, the interference ratio of sector 302A may refer to an interference that may modify a signal at location 304 in a disruptive manner as the signal travels along a communication channel between its source and a receiver.

Referring again to FIGS. 1A and 2, in an exemplary embodiment, step 106 may include assigning each respective KPI of the first plurality of KPIs to a respective point in a first points subset of the plurality of points. Exemplary points in the first points subset (for example, a point 206) are represented by solid circles in FIG. 2.

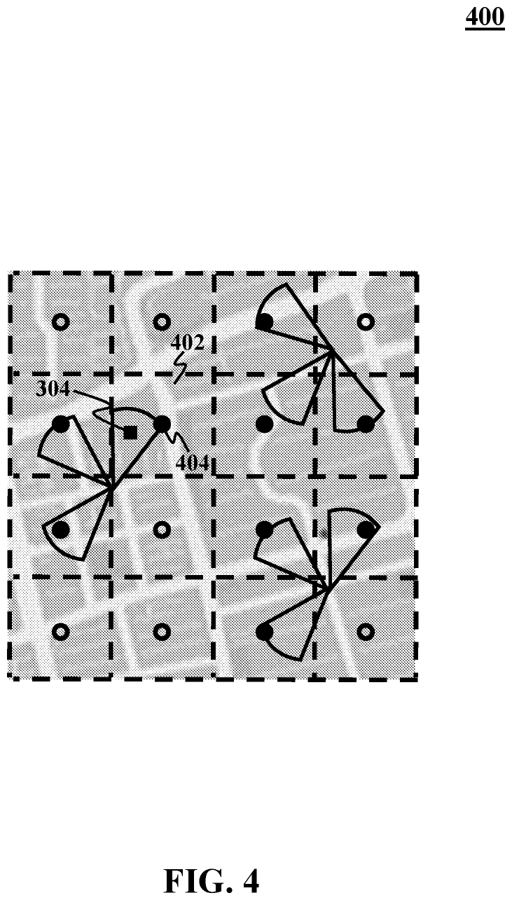

For further detail with regards to step 106, FIG. 4 shows a schematic of a cellular network in a geographical region divided into a plurality of areas, consistent with one or more exemplary embodiments of the present disclosure. Referring to FIGS. 3 and 4, an exemplary cellular network 400 may be similar to cellular network 300 and may include similar components as cellular network 300. In an exemplary embodiment, assigning each respective KPI to the respective point in the first points subset in step 106 may include assigning each respective KPI to a point of the plurality of points that may represent an area of the plurality of areas that may contain the respective point. For example, location 304 is located inside an area 402. Therefore, in an exemplary embodiment, the KPI extracted at location 304 may be assigned to a point 404 since point 402 represents area 404. As a result, in an exemplary embodiment, the first point subset may be constructed of points that are inside areas that may contain locations satisfying Inequation (1). Furthermore, KPIs of exemplary points in the first points subset may be extracted at corresponding locations obtained from Inequation (1).

In further detail regarding step 108, FIG. 1B shows a flowchart for estimating a second plurality of KPIs for a second points subset, consistent with one or more exemplary embodiments of the present disclosure. In an exemplary embodiment, estimating the second plurality of KPIs for the second points subset may include extracting a plurality of neighboring points of a respective point in the second points subset from the first points subset (step 114) and estimating a respective KPI of the second plurality of KPIs for the respective point (step 116).

Referring again to FIGS. 1B and 2, an exemplary second points subset may include every point of the plurality of points outside the first points subset. Exemplary points in the second points subset are represented by hollow circles in FIG. 2. For example, point 204 belongs to the second points subset.

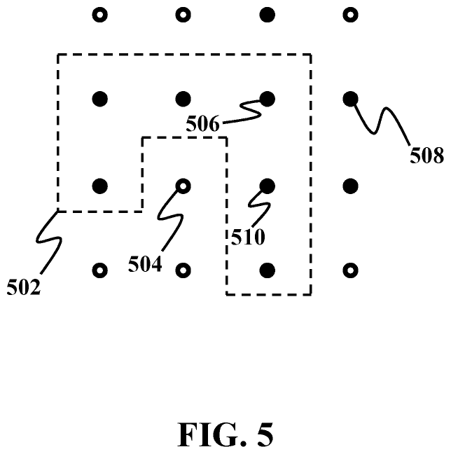

In further detail with respect to step 114, FIG. 5 shows a schematic of a plurality of neighboring points of a respective point, consistent with one or more exemplary embodiments of the present disclosure. Referring to FIGS. 1B and 5, in an exemplary embodiment, step 114 may include extracting a plurality of neighboring points 502 of a respective point 504 in the second points subset from the first points subset. In an exemplary embodiment, plurality of neighboring points 502 may include points in the first points subset that have smaller distances than other points in the first points subset from point 504. For example, a point 506 may be closer than a point 508 to point 504. Therefore, in an exemplary embodiment, plurality of neighboring points 502 may be obtained by sorting points in the first points subset based on their respective distances to point 504 and selecting a number of points that may be closest to point 504 among the sorted points. In an exemplary embodiment, 6 to 8 points may be selected from the first points subset to construct plurality of neighboring points 502. In an exemplary embodiment, each of the 6 to 8 points may have smaller distances than other points in the first points subset from point 504.

In an exemplary embodiment, step 116 may include estimating a respective KPI of the second plurality of KPIs for point 504 based on KPIs of the first plurality of KPIs that may be assigned to plurality of neighboring points 502. In an exemplary embodiment, estimating a KPI for point 504 may include interpolating values of KPIs that are assigned to plurality of neighboring points 502. In an exemplary embodiment, interpolating the values of the KPIs may include applying an inverse distance weighting interpolation method to the values of the KPIs. In an exemplary embodiment, the “inverse distance weighting interpolation method” may refer to an interpolation method that estimates a KPI for point 504 by weighted averaging KPI values of plurality of neighboring points 502. An exemplary weight that may be assigned to each KPI value may be inversely proportional with a distance between point 504 and a point corresponding to the KPI value. For example, a larger weight may be assigned to a KPI value of a point 510 compared to a KPI value of point 506 since point 510 is closer than point 506 to point 504 Therefore, exemplary points that are located closer to point 504 may have larger contribution in estimating the KPI for point 504.

Referring again to FIGS. 1A and 2, in an exemplary embodiment, step 110 may include estimating a respective level of frequency interference at each respective point (for example, point 204 or point 206) of the plurality of points based on the first plurality of KPIs and the second plurality of KPIs. In an exemplary embodiment, estimating the respective level of frequency interference at each respective point (for example, point 204 or point 206) may include calculating a difference between a value of a respective KPI of one of the first plurality of KPIs or the second plurality of KPIs and a KPI threshold. An exemplary respective KPI may be associated with each respective point.

For each exemplary point in the first points subset (represented by solid circles in FIG. 2 such as point 206), a corresponding KPI of the first plurality of KPIs may be extracted from an exemplary database as described in steps 104 and 106 above. As a result, for each exemplary point in the first points subset (such as point 206), an exemplary level of frequency interference may be estimated by calculating a difference between a value of a corresponding KPI of the first plurality of KPIs and an exemplary KPI threshold.

For each exemplary point in the second points subset (represented by hollow circles in FIG. 2 such as point 204), a corresponding KPI of the second plurality of KPIs may be estimated as described in step 108 above. As a result, for each exemplary point in the second points subset (such as point 204), an exemplary level of frequency interference may be estimated by calculating a difference between a value of a corresponding KPI of the second plurality of KPIs and an exemplary KPI threshold.

Referring again to FIG. 3, an exemplary KPI threshold may be set based on a type of exemplary KPIs. In an exemplary embodiment, if an RSSI of each sector in cellular network 300 is used as a KPI, the KPI threshold may be set to a value in a range of about −110 dbm to about −90 dbm. In an exemplary embodiment, if an interference ratio of each sector in cellular network 300 is used as a KPI, the KPI threshold may be set to a value in a range of about 3 to about 4. An exact value of an exemplary KPI threshold may depend on the technology of cellular network 300 (for example, 2G, 3G, LTE, 5G, etc.).

Referring again to FIGS. 1A and 2, in an exemplary embodiment, step 112 may include displaying a distribution map of frequency interference in geographical region 200. An exemplary distribution map may be displayed by representing a respective level of frequency interference at each respective point (for example, point 202 or point 204) of the plurality of points on the distribution map.

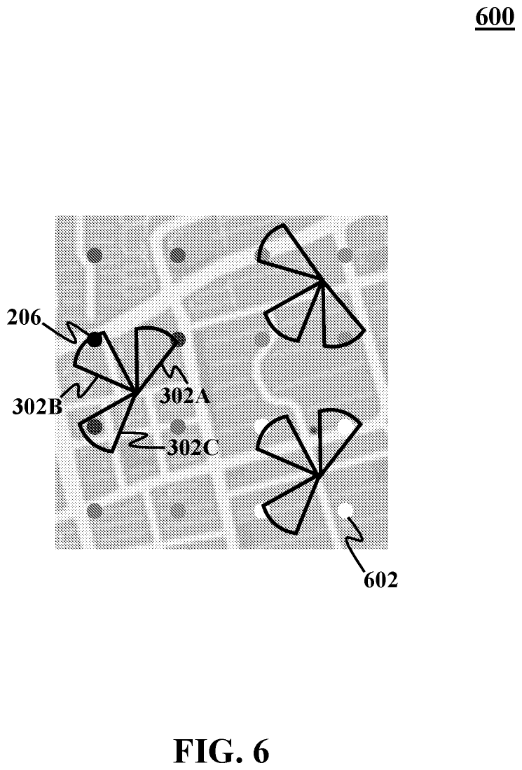

FIG. 6 shows a schematic of a distribution map, consistent with one or more exemplary embodiments of the present disclosure. In an exemplary embodiment, displaying a distribution map 600 may include assigning a color level to each respective point in distribution map 600. An exemplary color level may be proportional to a difference between a value of a KPI and a respective threshold. For example, a black color may be assigned to point 206, indicating a large negative difference between a KPI value at point 206 and a threshold value corresponding to the KPI. In distribution map 600, darker points indicate higher levels of frequency interference at those points, whereas brighter points indicate lower levels of frequency interference. For example, a point 602 is represented as white, indicating a large positive difference between a KPI value at point 602 and a threshold value corresponding to the KPI. Therefore, no frequency interference may be present at point 602.

An exemplary method may further include detecting external sources of frequency interference. FIG. 1C shows a flowchart of a method for detecting external sources of frequency interference, consistent with one or more exemplary embodiments of the present disclosure. An exemplary method 118 may include selecting one or more sectors from the plurality of sectors for anomaly detection according to the distribution map (step 120), detecting one or more abnormal sectors among the one or more sectors by applying an anomaly detection method to the one or more sectors (step 122), and estimating a number of the external sources of frequency interference by determining a number of different anomalies within the one or more abnormal sectors (step 124).

In further detail with regards to step 120, exemplary sectors that are present near points with high levels of frequency interference in distribution map 600 may be selected for anomaly detection. For example, sectors 302A, 302B, and 302C in FIG. 6 may be selected for anomaly detection since they are located in zones represented by dark gray or black points, implying presence of high levels of frequency interference in those regions.

For further detail with respect to step 122, in an exemplary embodiment, one or more abnormal sectors may be detected among the one or more sectors (selected in step 120 above) by applying an anomaly detection method to the one or more sectors. An exemplary anomaly detection method may include assessing a set of conditions for each respective sector (for example, each of sectors 302A, 302B, and 302C) of the one or more sectors. An exemplary set of conditions for an exemplary sector may be defined by the following:

KPI_{today}−KPI_{average}>5 Inequation (2a)

KPI_{today}>KPI_{threshold} Inequation (2b)

KPI_{today}−KPI_{yesterday}>2 Inequation (2c)

KPI_{average}−TR×SD<KPI_{today} Inequation (2d)

where KPI_{today} represents a value of an exemplary KPI of the first plurality of KPIs that may be extracted for the exemplary sector at the given time, KPI_{average} represents an average value of the exemplary KPI over 20 days prior to the given time, KPI_{threshold} is a threshold value, KPIyesterday represents a value of the exemplary KPI at a day preceding the given time, TR is a constant, and SD is a standard deviation of values of the exemplary KPI over the 20 days. An exemplary value of KPI_{threshold} may be determined based on a type of the exemplary KPI, as described above in step 110. An exemplary value of TR may be determined based on characteristics of cellular network 300 (such as number and density of cells in geographical region 200) and may be set to about 2 for a conventional network.

An exemplary anomaly detection method may further include determining an exemplary sector as an abnormal sector of the one or more abnormal sectors responsive to the set of conditions being satisfied. In an exemplary embodiment, if a KPI value of an exemplary sector (for example, sector 302A) satisfies the set of conditions defined by Inequation (2a)-(2d), the exemplary sector may be considered abnormal according to the anomaly detection method.

In further detail regarding step 124, in an exemplary embodiment, the number of external sources of frequency interference may be considered equal to the number of different anomalies within the one or more abnormal sectors. In an exemplary embodiment, the number of different anomalies may be determined by extracting a plurality of variation patterns for respective KPIs of the first plurality of KPIs that may have been extracted for each abnormal sector among the one or more abnormal sectors (as described in step 104 above) over 20 days prior to the given time. In an exemplary embodiment, a variation pattern may include a change of a KPI value at an exemplary day with respect to an average value of the KPI during days before the exemplary day. If an exemplary KPI varies significantly compared to its average value in preceding days of an exemplary day, a variation pattern of the exemplary KPI may be considered to be different in the exemplary day from its variation pattern in days preceding the exemplary day. In an exemplary embodiment, if two different KPIs of two different abnormal sectors have changed in their variations at a same exemplary day, the two different KPIs may be considered to have a same anomaly at the exemplary day. In other words, in an exemplary embodiment, it may be assumed that a single external source of frequency interference may have caused the change (i.e., anomaly) in variation patterns of the two different KPIs. In an exemplary embodiment, the number of different anomalies in the one or more abnormal sectors may be considered equal to a number of different variation patterns among the plurality of variation patterns.

In an exemplary embodiment, method 100 may further include removing the external sources of frequency interference. For this purpose, exemplary locations of abnormal sectors may be searched to find potential sources of frequency interference. An exemplary search may be continued until a number of different potential sources of frequency interference that may be equal to the number of external sources of frequency interference determined in step 124 may be found and removed.

In an exemplary embodiment, method 100 may further include evaluating performance of the one or more abnormal sectors by applying a change point detection method to the one or more abnormal sectors over a time range. In an exemplary embodiment, a “change point detection method” may refer to a method that identifies times when statistical characteristics of a sector changes. An exemplary time range may include about 20 days before removing the external sources and about 10 days after removing the external sources.

In an exemplary embodiment, method 100 may further include determining removal of frequency interference responsive to the performance being improved after removing the external sources. In an exemplary embodiment, if the performance of abnormal sectors is improved after removing potential sources of frequency interference, it may be determined that frequency interference is eliminated in regions that contain the abnormal sectors.

In an exemplary embodiment, method 100 may further include determining existence of frequency interference responsive to the performance being degraded after removing the external sources. In an exemplary embodiment, if the performance of abnormal sectors continues to degrade after removing potential sources of frequency interference, it may be determined that frequency interference is still present in regions that contain the abnormal sectors.

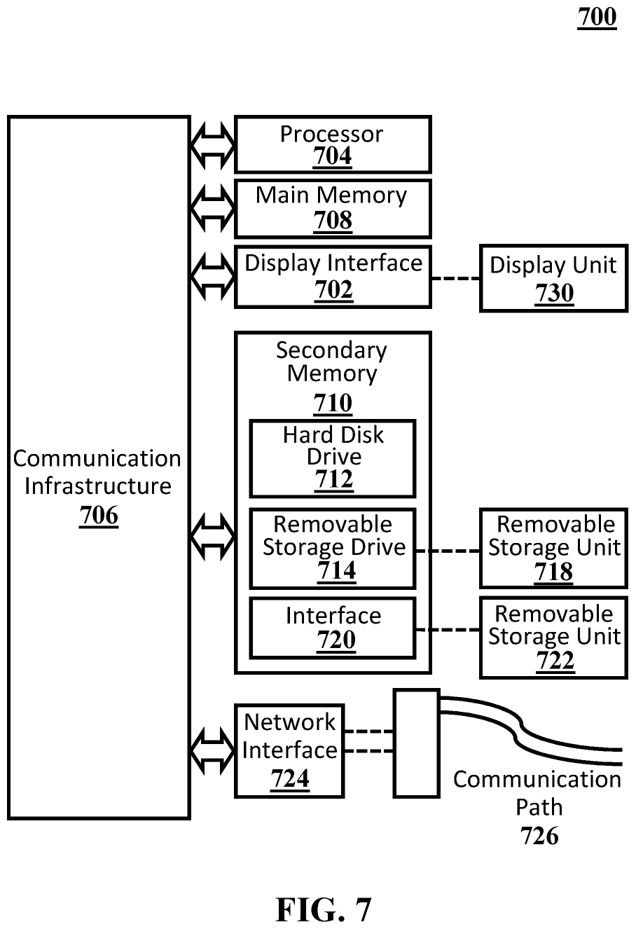

FIG. 7 shows an example computer system 700 in which an embodiment of the present invention, or portions thereof, may be implemented as computer-readable code, consistent with exemplary embodiments of the present disclosure. For example, different steps of method 100 may be implemented in computer system 700 using hardware, software, firmware, tangible computer readable media having instructions stored thereon, or a combination thereof and may be implemented in one or more computer systems or other processing systems. Hardware, software, or any combination of such may embody any of the modules and components in FIGS. 1A-6.

If programmable logic is used, such logic may execute on a commercially available processing platform or a special purpose device. One ordinary skill in the art may appreciate that an embodiment of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

An embodiment of the invention is described in terms of this example computer system 400. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose (e.g., a graphical processing unit) or a general-purpose processor device. As will be appreciated by persons skilled in the relevant art, processor device 704 may also be a single processor in a multi-core/multiprocessor system, such system operating alone, or in a cluster of computing devices operating in a cluster or server farm. Processor device 704 may be connected to a communication infrastructure 706, for example, a bus, message queue, network, or multi-core message-passing scheme.

In an exemplary embodiment, computer system 700 may include a display interface 702, for example a video connector, to transfer data to a display unit 730, for example, a monitor. Computer system 700 may also include a main memory 708, for example, random access memory (RAM), and may also include a secondary memory 710. Secondary memory 710 may include, for example, a hard disk drive 712, and a removable storage drive 714. Removable storage drive 714 may include a floppy disk drive, a magnetic tape drive, an optical disk drive, a flash memory, or the like. Removable storage drive 714 may read from and/or write to a removable storage unit 718 in a well-known manner. Removable storage unit 718 may include a floppy disk, a magnetic tape, an optical disk, etc., which may be read by and written to by removable storage drive 714. As will be appreciated by persons skilled in the relevant art, removable storage unit 718 may include a computer usable storage medium having stored therein computer software and/or data.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 which allow software and data to be transferred from removable storage unit 722 to computer system 700.

Computer system 700 may also include a communications interface 724. Communications interface 724 allows software and data to be transferred between computer system 700 and external devices. Communications interface 724 may include a modem, a network interface (such as an Ethernet card), a communications port, a PCMCIA slot and card, or the like. Software and data transferred via communications interface 724 may be in the form of signals, which may be electronic, electromagnetic, optical, or other signals capable of being received by communications interface 724. These signals may be provided to communications interface 724 via a communications path 726. Communications path 726 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 718, removable storage unit 722, and a hard disk installed in hard disk drive 712. Computer program medium and computer usable medium may also refer to memories, such as main memory 708 and secondary memory 710, which may be memory semiconductors (e.g. DRAMs, etc.).

Computer programs (also called computer control logic) are stored in main memory 708 and/or secondary memory 710. Computer programs may also be received via communications interface 724. Such computer programs, when executed, enable computer system 700 to implement different embodiments of the present disclosure as discussed herein. In particular, the computer programs, when executed, enable processor device 704 to implement the processes of the present disclosure, such as the operations in method 100 illustrated by flowcharts of FIGS. 1A-FIG. 1C discussed above. Accordingly, such computer programs represent controllers of computer system 700. Where an exemplary embodiment of method 100 is implemented using software, the software may be stored in a computer program product and loaded into computer system 700 using removable storage drive 714, interface 720, and hard disk drive 712, or communications interface 724.

Embodiments of the present disclosure also may be directed to computer program products including software stored on any computer useable medium. Such software, when executed in one or more data processing device, causes a data processing device to operate as described herein. An embodiment of the present disclosure may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A method for frequency interference detection in a geographical region at a given time, the method comprising:
dividing the geographical region into a plurality of areas, each of the plurality of areas represented by a respective point of a plurality of points;
extracting a first plurality of key performance indicators (KPIs) from a database stored in an operations support system (OSS) of a cellular network, the cellular network comprising a plurality of cells, each of the plurality of cells comprising three sectors of a plurality of sectors, each respective KPI of the first plurality of KPIs associated with a respective sector of the plurality of sectors;
assigning each respective KPI of the first plurality of KPIs to a respective point in a first points subset of the plurality of points;
estimating, utilizing one or more processors, a second plurality of KPIs based on the first plurality of KPIs for a second points subset of the plurality of points, the second points subset comprising every point of the plurality of points outside the first points subset;
estimating, utilizing the one or more processors, a respective level of frequency interference at each respective point of the plurality of points based on the first plurality of KPIs and the second plurality of KPIs; and
displaying a distribution map of frequency interference in the geographical region by representing the respective level of frequency interference at the each respective point of the plurality of points on the distribution map.

2. The method of claim 1, wherein dividing the geographical region into the plurality of areas comprises dividing the geographical region into a plurality of equal square-shaped zones, each respective zone of equal square-shaped zones represented by a respective point of the plurality of points, the respective point located at a center of the respective zone.

3. The method of claim 1, wherein extracting the first plurality of KPIs comprises extracting the each respective KPI for a respective location at a respective distance from a respective sector of the plurality of sectors along an azimuth direction of the respective sector, the respective distance defined by the following:
$$0.15 \times {d}_{min} \leq {d}_{s} \leq 0.45 \times {d}_{min}$$
where:
dₘᵢₙ is a minimum distance between the respective sector and a closest cell among the plurality of cells to a respective cell of the plurality of cells, the respective cell comprising the respective sector, and
dₛ is the respective distance.

4. The method of claim 3, wherein assigning the each respective KPI to the respective point in the first points subset comprises assigning the each respective KPI to a point of the plurality of points representing an area of the plurality of areas containing the respective point.

5. The method of claim 4, wherein extracting the each KPI for the respective location comprises extracting one of a received signal strength indicator (RSSI) or an interference ratio of the respective sector at the respective location.

6. The method of claim 1, wherein estimating the second plurality of KPIs for the second points subset comprises:
extracting a plurality of neighboring points of a respective point in the second points subset from the first points subset, the plurality of neighboring points comprising points in the first points subset having smaller distances than other points in the first points subset to the respective point in the second points subset; and
estimating a respective KPI of the second plurality of KPIs for the respective point based on KPIs of the first plurality of KPIs assigned to the plurality of neighboring points.

7. The method of claim 6, wherein estimating the respective KPI for the respective point comprises interpolating values of the KPIs assigned to the plurality of neighboring points.

8. The method of claim 7, wherein interpolating the values of the KPIs comprises applying an inverse distance weighting interpolation method to the values of the KPIs.

9. The method of claim 6, wherein extracting the plurality of neighboring points from the first points subset comprises selecting 6 to 8 points of the first points subset, each of the 6 to 8 points having smaller distances than other points in the first points subset to the respective point.

10. The method of claim 1, wherein estimating the respective level of frequency interference at the each respective point comprises calculating a difference between a value of a respective KPI of one of the first plurality of KPIs or the second plurality of KPIs and a KPI threshold, the respective KPI associated with the each respective point.

11. The method of claim 1, wherein displaying the distribution map comprises assigning a color level to the each respective point in the distribution map, the color level proportional to the difference between the value of the respective KPI and the respective threshold.

12. he method of claim 1, further comprising:
detecting, utilizing the one or more processors, external sources of frequency interference by:
selecting one or more sectors from the plurality of sectors for anomaly detection according to the distribution map;
detecting one or more abnormal sectors among the one or more sectors by applying an anomaly detection method to the one or more sectors; and
estimating a number of the external sources of frequency interference by determining a number of different anomalies within the one or more abnormal sectors.

13. The method of claim 12, wherein applying the anomaly detection method to the one or more sectors comprises:
assessing a set of conditions for each respective sector of the one or more sectors, the set of conditions defined by the following:
$${KPI}_{today} - {KPI}_{average} > 5 ,$$
$${KPI}_{today} > {KPI}_{threshold} ,$$
$${KPI}_{today} - {KPI}_{yesterday} > 2 , and$$
$${KPI}_{average} - T R \times S D < {KPI}_{today} , .$$
where:
KPI_{today} represents a value of a respective KPI of the first plurality of KPIs at the given time, the respective KPI associated with the each respective sector,
KPI_{average} represents an average value of the respective KPI over 20 days prior to the given time,
KPI_{threshold} is a threshold value associated with the respective KPI, KPIyesterday represents a value of the respective KPI at a day preceding the given time, TR is a constant, and
SD is a standard deviation of values of the respective KPI over the 20 days; and
determining the each respective sector as an abnormal sector of the one or more abnormal sectors responsive to the set of conditions being satisfied.

14. The method of claim 13, wherein determining the number of different anomalies comprises:
extracting a plurality of variation patterns for respective KPIs of the first plurality of KPIs associated with the one or more abnormal sectors over 20 days prior to the given time; and
determining the number of different anomalies as a number of different variation patterns among the plurality of variation patterns.

15. The method of claim 12, further comprising:
removing the external sources of frequency interference;
evaluating, utilizing the one or more processors, performance of the one or more abnormal sectors over a time range comprising 20 days before removing the external sources and 10 days after removing the external sources by applying a change point detection method to the one or more abnormal sectors;
determining removal of frequency interference responsive to the performance being improved after removing the external sources; and
determining existence of frequency interference responsive to the performance being degraded after removing the external sources.
